(19) United States
(12) Patent Application Publication
(10) Pub. No.: US 2026/0328639 A1
(43) Pub. Date: Oct. 22, 2026

(54) Sensing system for measuring physical parameters of a stay cable and method thereof

(71) Applicant: VSL International AG, Bern (CH)

(72) Inventors: Rachid Annan, Rapperswil (CH); Jean-Baptiste Domage, Bern (CH); Simon Ruas, Belfaux (CH)

(21) Appl. No.: 19/109,470

(22) PCT Filed: Sep. 12, 2022
(86) PCT No.: PCT/EP2022/075212

§ 371 Date: Mar. 6, 2025

(51) Int. Cl. G01M 5/00

(52) U.S. Cl. CPC G01M 5/0008; G01M 5/0025; G01M 5/0066

(57) ABSTRACT

Present invention relates to a sensing system (100), a load-bearing element (500) comprising said sensing system and a method of installing the sensing system thereof. Present invention aims to provide a sensing system (100) for measuring physical parameters, such as temperature, humidity, acceleration, gas signature, light, vibration and/or motion. The present invention comprises a height adjustable sensing device (20) comprising a substantially tubular casing (12), a wire (16) for transmitting data and/or for hoisting or lowering the height adjustable sensing device (20), wherein one end of the height adjustable sensing device (20) is connected to the wire (16). The present invention specifically relates to a sensing system (100) for measuring physical parameters of a structural or tensioning element such as a stay cable or tendon, wherein the structural or tensioning element comprises a recipient (520) as a housing, wherein the sensing system (100) is at least partially provided within the recipient (520), comprising (a) A height adjustable sensing device (20) comprising a substantially tubular casing (12) provided within the recipient (520), wherein at least one sensor is provided within the tubular casing (12); (b) A wire (16) for transmitting data and/or for hoisting or lowering the height adjustable sensing device (20), wherein one end of the height adjustable sensing device (20) is connected to the wire (16) so as to allow the sensing device (20) to reach any length of the structural or tensioning element.

### TECHNICAL FIELD OF THE INVENTION

Present invention relates to the field of civil engineering involving structural elements e.g., building, or tensioning elements e.g., bridge cable; wherein a sensing system can be applied to the load-bearing structures or elements for measuring physical parameters of said structures or elements. The invention also relates to a method of installing said system on the element for measuring physical parameters.

### BACKGROUND OF THE INVENTION

In general, civil engineering structures in the modern days such as buildings, suspended roofs, bridges (e.g., stayed bridge, suspension bridge), cable-stabilized structures are built larger and taller. Due to the external environmental factors such as passing traffics, earthquakes, fatigue or internal factors, these civil engineering structures may be subject to shorter life span if they are not being properly maintained. Moreover, in order to check the adequate behaviour of these structural elements and tensioning elements and the compliance with the relevant standards, various types of sensors are used for evaluating their practicality and safety.

Accelerometer sensors for example are instruments for measuring acceleration of any body or object. Accelerometer sensors can be used in many ways to detect changes in velocity and position, such as in many electronic devices, smartphones, and wearable devices as well as in the aforementioned large civil engineering structures, where they are used to monitor vibrations and movements.

Patent document CN212779344U relates to a system which is employed to monitor bridges. The bridge is equipped with sensor devices in order to monitor its condition and to make sure it is safe to be used. The sensor devices such as accelerometers are typically mounted on the outer surface of the bridge structure, such as on the outer periphery of a cable, or on the deck to detect motions or vibrations. The sensor box which is mounted on the outer surface of the cable is therefore exposed to the environment. The sensor box is therefore subjected to quicker aging effect and requires regular maintenance. Moreover, if the sensor box is mounted on the tendon cable, the tendon cable will be affected by wind load and will introduce torsional or other type of not anticipated load on the tendon. In addition, in such existing solutions, it is necessary to access at height in order to install the sensor box on the tendon.

It is moreover known that oscillations and vibrations of bridges and cables generally differ from each other based on the frequency of oscillations and the amplitude of the vibrations, which may vary depending on various factors such as the speed of wind, the presence or intensity of rain and the impact of vehicles or objects on the bridge. Moreover, different sections or regions of the cable may experience different degree of oscillations and vibrations.

Moreover, in the example of stay cables, different height or location of the stay cable may be subject to different environmental impacts such as temperature, vibrations, accelerations, motion, wind load and etc. Therefore, it may be essential to measure the physical parameters of the structures at different positions or heights.

It is therefore envisaged to provide a new system and a method to overcome at least part of the aforementioned problems.

### SUMMARY OF THE INVENTION

In the present invention, it is proposed that a sensing system comprising a height adjustable sensing device is provided in an internal cavity of a structural element or tensioning element for measuring physical parameters of structural elements such as stay cables. This sensing device may be for example an acceleration sensing device for measuring acceleration or other sensing devices for measuring for instance temperature, gas content, humidity, light, pressure, etc. Contrary to the prior art, the sensing device or at least part of the sensing system of the present invention is not mounted or fixed at a surface of a recipient. This allows an easy installation or retrieval of the device as well as it allows detection at different positions or heights of the recipient.

The sensing device according to the present invention is at least partially, if not fully, incorporated inside the recipient such as the free length of a stay pipe. Therefore, it is not exposed to the environmental factors e.g., rain, wind, snow and etc, and hence allowing for longer lifespan and lower maintenance requirements.

In addition, thanks to a wire that is provided to the sensing device, the position of the sensing device as well as the system can be adjusted easily by lifting or lowering the device or the system within its recipient through said wire.

Moreover, as the casing of the sensing device is provided with a substantially tubular shape (or with slight edges or corners) which is placed within an internal cavity of a recipient such as a bridge pipe, different faces or sides of the sensing device could thus be in contact with the internal surface of the recipient element. For instance, in case of a tubular casing, the sensing device moves or rolls in relation to the movement initiated by the recipient.

The sensing device may be a component of a sensing system comprising a data transmission system such as a data wire or a wireless transmitter and a datalogger to process data.

In the particular case of the acceleration sensing device, the sensing system is not mounted at a fixed position, hence a pre-treatment of the signals may be carried out where the input raw signal is treated in order to calculate the reference signal that corrects the random axial orientation of the acceleration sensing device before generating an output signal.

According to a first aspect of the invention, it relates to a sensing system for measuring physical parameters of structural or tensioning element such as a stay cable or tendon, wherein the structural or tensioning comprises a recipient as a housing, wherein the sensing system is at least partially provided within the recipient such as pipe, comprising
a height adjustable sensing device comprising a substantially tubular casing provided within the recipient, wherein at least one sensor is provided within the tubular casing;
a wire for transmitting data and/or for hoisting or lowering the height adjustable sensing device, wherein one end of the height adjustable sensing device is connected to the wire so as to allow the sensing device to reach any length of the structural or tensioning element.

According to a second aspect of the invention, it relates to a load-bearing element for constructions, comprising
a plurality of tensile elements;
a recipient having an internal cavity such as a pipe for encasing the tensile elements;
a sensing system according to any one of the preceding claims, wherein at least part of the sensing system or the height adjustable sensing device is placed within the recipient without being mounted on a surface of the recipient, allowing the sensing device to reach any length of the recipient.

According to a third aspect of the invention, it relates to a method of installing a sensing system to a load-bearing element for measuring physical parameters of the load-bearing element such as vibrations and/or motion, comprising the steps of:
providing tensile elements to a recipient having internal cavity such as a pipe;
providing a sensing system according to any one of the preceding claims 1 to 9 to the load-bearing element, comprising at least one height adjustable sensing device having a substantially tubular casing, wherein the height adjustable sensing device is located within the recipient without being mounted, wherein at least one end of the height adjustable sensing device is connected to a wire which in turn is anchored to an anchoring area, allowing the sensing device to reach any length of the recipient;

In one embodiment of the invention, the sensing system comprises at least one acceleration sensing device, temperature sensing device, humidity sensing device, gas signature sensing device and/or proximity sensing device.

In one embodiment of the invention, when the sensing device comprises an acceleration sensing device such as accelerometer, the accelerometer comprises at least two single-axis accelerometers, or at least one biaxial accelerometer, or at least one triaxial accelerometer, or a combination thereof.

In one embodiment of the invention, when the sensing device comprises an acceleration sensing device such as accelerometer, the accelerometer is capable of measuring low frequency of between 0 Hz and 100 Hz, preferably between 0 Hz and 50 Hz.

In one embodiment of the invention, when the sensing device comprises an acceleration sensing device such as accelerometer, the accelerometer is capable of measuring 0 Hz acceleration and measuring low frequency motion and/or constant acceleration.

In one embodiment of the invention, when the sensing device comprises an acceleration sensing device such as accelerometer, a datalogger device is provided to the sensing system to connect with the height adjustable acceleration sensing device for storing and processing of signals.

In one embodiment of the invention, the sensing system further comprises a transmitting device for broadcasting data to one or more relevant receivers.

In one embodiment of the invention, the sensing system further comprises a memory for storing information.

In one embodiment of the invention, when the sensing device comprises an acceleration sensing device such as accelerometer, further comprises a microprocessor for processing signals generated by the height adjustable acceleration sensing device in relation to their reference signal to provide an output, wherein the reference signal is obtained upon sensor calibration according to sensor datasheet parameters followed by sensor orientation correction to allow correction of signals without control of position orientation of the height adjustable acceleration sensing device.

In one embodiment of the invention, a datalogger device is provided to an upstream or a downstream of the load-bearing element.

In one embodiment of the invention, the datalogger device is provided to be located within or outside of the recipient, comprising a memory for storing data, and a microprocessor for processing signals generated by the height adjustable sensing device.

In one embodiment of the invention, when the sensing device comprises an accelerometer as an acceleration sensing device, the method further comprising steps of
connecting the height adjustable acceleration sensing device with a datalogger device;
generating output signals.

In one embodiment of the invention, the method further comprising a step of hoisting or lowering the wire for adjusting the position of the height adjustable sensing device and/or height adjustable sensing system to reach any length of the recipient.

By “about” or “approximately” in relation to a given numerical value, it is meant to include numerical values within 10% of the specified value. All values given in the present disclosure are to be understood to be complemented by the word “about” unless it is clear to the contrary from the context.

The indefinite article “a” or “an” does not exclude a plurality, thus should be treated broadly.

The term “structural element” as used herein refers to a basic component of a building structure which forms a structural frame building structure such as beams, pillars, roof terraces, slabs, columns, girders and/or other structural members and connections.

The term “tensioning element” as used herein refers to an element which carries tension and no compression. The tensioning element may be provided to a structural element such as a bridge cable in order to support the main deck where the traffics flow. The tensioning element described herein may be for instance a tendon. The expressions “perpendicular in relation” or “substantially perpendicular” in relation to the direction of the sensors shall be understood as examples and do not exclude other possible configurations of the said element e.g., accelerometers. In particular, the accelerometers may be installed in any two different axial directions, provided that these two different directions allow to calculate the projection of the accelerations on two perpendicular axis. It would be possible, for instance, to install three accelerometers at 60° or two accelerometer at any angle different from 90°.

The term “height adjustable” as used herein is interchangeably used with the term “mounting-less”, and it refers to an object that is not physically fixed completely to a support, which is contrary to the term “mount” where an object is made completely static and dependent on its support. For instance, “height adjustable” means that the position or the height of the object can be adjusted e.g., move within the stay pipe from a location to another. In other words, the height adjustable sensing device is capable of hanging within the pipe of the stay cable, allowing the position of the sensing device to be adjusted to reach any length of the stay cable. The term “mounting-less” may include the definition that the object may be dangled, hung or swung loosely having only a part attached to a support while the positioning of the element is not completely static, as the term “mount” would have implied.

The term “reference signal” as used herein refers to a signal which has been corrected for the random axial orientation of the accelerometer, wherein it is generated upon sensor calibration according to sensor datasheet parameters followed by correction of the sensor orientation according to adequate mathematical treatment. For example, it can be understood that the reference signal is generated upon sensor calibration according to sensor datasheet parameters followed by sensor orientation correction, wherein the sensor orientation correction calculated from a projection of the averaged acceleration on the vertical axis, wherein the values are obtained from accelerometers installed on two different radial directions.

To this end, it is disclosed that the sensing system can be applied to any structural element e.g., roof, building, or tensioning element e.g., bridge cables, having an internal cavity, wherein the height adjustable sensing device comprising at least one sensor is provided therein, without need to be mounted.

### BRIEF DESCRIPTION OF THE FIGURES

FIG. 1A shows a perspective view of a load-bearing element provided with a sensing system according to an embodiment of the invention.

FIG. 1B shows a cross sectional view of the embodiment according to the FIG. 1A.

FIG. 1C shows a perspective view of an acceleration sensing system according to a further embodiment of the invention.

FIG. 2 shows a perspective view of a part of an acceleration sensing system according to a further embodiment of the invention.

FIG. 3 is a depiction of an angular position of the accelerometer sensor according to a further embodiment of the invention.

FIG. 4 is a schematic flow chart of signal treatment according to an embodiment of the invention.

### DETAILED DESCRIPTION OF THE INVENTION

The inventors of the present invention propose a sensing system for measuring physical parameters of structural or tensioning elements such as stay cables or tendons, wherein the structural or tensioning element comprises a pipe as a housing, wherein the sensing system may for instance be at least partially provided within the pipe.

At least one sensing device that is capable of adjusting its position (e.g., height) within the pipe of the structural or tensioning element is provided within a casing. The positioning or height of the sensing device can be adjusted for instance via a wire attached to one far end of the sensing device so that the sensing device is capable of reaching any length of the stay cable, or any position of the structural element. To this end, it is disclosed that both far ends of the sensing device may also be provided with a wire to allow the sensing device to be height adjustable within the stay cable.

The sensing device is provided with at least one sensor which may be a temperature sensor, a humidity sensor, a gas sensor, a proximity sensor, a light sensor and/or an acceleration sensor.

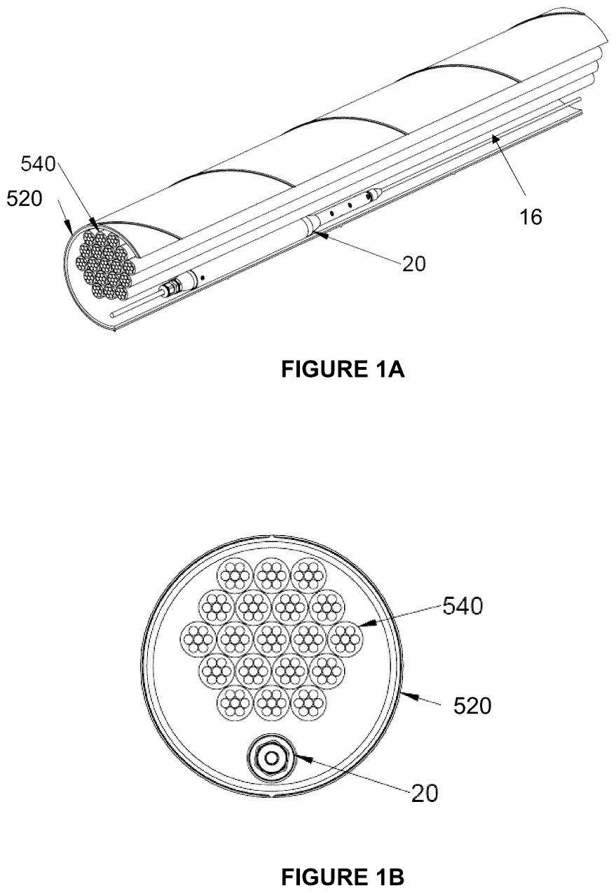

According to the FIG. 1A, at least part of the sensing system 100 i.e., sensing device 20 may be placed within its recipient 520 (e.g., a stay pipe 521) having tensile elements 540 where it serves as a load-bearing element 500 of a bridge cable. A space within the pipe 521 is observed in the FIG. 1A where a sensing device 20 is placed within said cavity. Through the wire 16 (e.g., hoisting wire 16b or the data wire 16a), the sensing device 20 can be lifted or lowered such as to reach different position of the pipe 521.

In other words, the system 100 according to the present invention is height adjustable, and that it can easily be installed, reposition, removed, and maintained from tendon termination through the wire 16. Moreover, as the sensing device 20 is able to reach different parts of its recipient 520 e.g., pipe 521, it is thus possible to detect physical properties such as oscillations, temperature, humidity, vibrations or motions of different parts of the pipe. This feature allows for instance to characterise the vibrations along the stay cable, as certain part of the cable and the pipe may suffer higher degree of motions or vibrations while another part of the pipe may suffer less.

Referring now to FIG. 1B, it illustrates a crossed-sectional view of the FIG. 1A where the sensing device 20 is located beneath of the plurality of tensile elements 540. As can be seen in this example, both the recipient 520 (e.g., pipe 521) and the casing of the sensing device 20 are provided with a substantially circular shape. As the sensing device 20 is not completely attached or mounted to its support, the sensing device 20 may be hanged or swinged freely on the recipient's surface.

To this end, it is reiterated that according to all the embodiments of the present invention, at least part of the sensing system 100 or preferably the entire sensing system 100 is integrated inside its recipient 520 such as the pipe 521. Therefore, said sensing system 100 is not exposed to the influence of the external environment and hence has a longer lifespan and better durability.

To the contrary, placing at least part of the sensing system 100 outside of a recipient such as a pipe 521 may also be suitable. For instance, the sensing device 20 may be situated within the pipe 521 while datalogger device 30 of the sensing system 100 may be located outside of the pipe 521.

Of course, it is foreseen that preferably all elements of the sensing system 100 are located inside of the pipe 521. This has the advantage to further reduce load such as wind load as it is one of the main factors which causes vibrations or movements. FIG. 1C illustrates an example where the components of the sensing system 100 (e.g., sensing device 20 and datalogger device 30) are located within its housing e.g., pipe 521. In this particular embodiment, an acceleration sensing device 21 is shown as a preferred example.

It becomes apparent that the sensing system 100 according to the present invention can be wired to data network with fully encased and protected by its recipient 520 such as the stay pipe 521 for durability, and without need of additional sheathing. Of course, data can be transmitted also wirelessly, hence no data wire 16a is required for the acceleration sensing device 20.

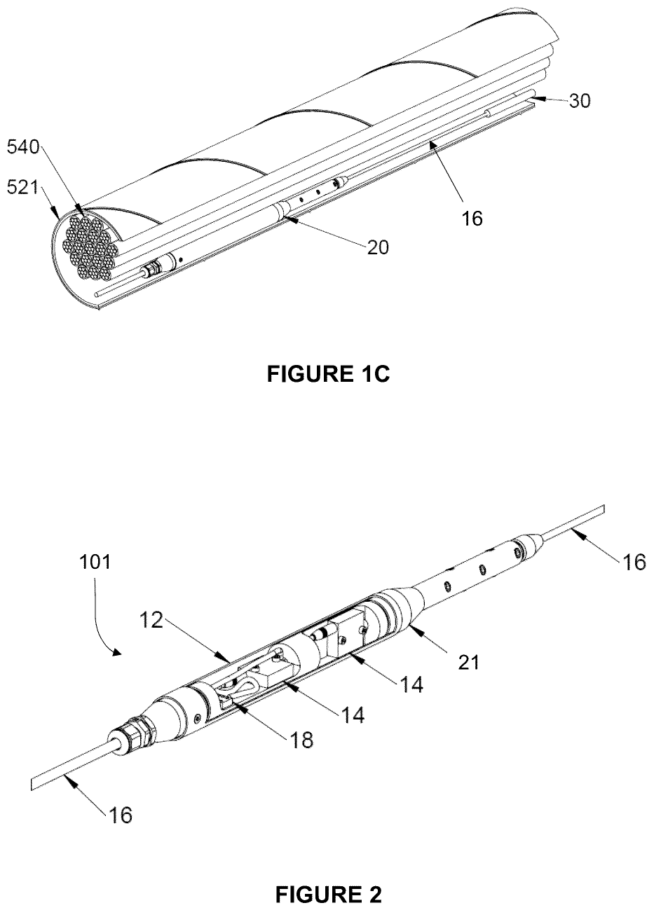

FIG. 2 demonstrates an embodiment of one particular type of sensing device, that is the acceleration sensing device 21 of the acceleration sensing system 101. The mounting-free or height adjustable acceleration sensing device 21 according to the present invention is provided in a predominantly tubular form, wherein a substantially circular casing 12 is provided to the acceleration sensing device 21. The advantage of providing a smooth, circular surface (tubular casing) is that the casing of the acceleration sensing device 21 can be contacted with its pipe 521 which may also have a curved surface e.g., circular. In this way, the acceleration sensing device 21 is able to swing loosely, roll or dangle freely on its surface.

To this end, it is disclosed that the casing does not necessarily have to be a circular or a tubular shape. Other suitable shapes such as having multi-edges (square, pentagon, hexagon, irregular shapes) may also be suitable to be provided as the casing 12 of the acceleration sensing device 21.

The acceleration sensing device 21 is provided for generating signals for example from at least two different axial directions which may be in substantial perpendicular relation. Thanks to the capability of the acceleration sensing system 101 according to the present invention to self-correct signals due to random axial orientation of the acceleration sensing device 21, the acceleration sensing system 101 or at least the acceleration sensing device 21 can therefore be installed without controlling the orientation. The acceleration sensing device 21 may be connected to a microprocessor via a data transmission system to routinely process and to assess the actual orientation of the device and to provide correction thereof to allow output signals to be generated. Hence, the acceleration sensing device 21 or at least part of the acceleration sensing system is not required to be mounted at a fixed position so as to allow to reach to any location (or height) within the pipe of the stay cable.

The acceleration sensing device 21 may comprise at least one accelerometer 14 for generating at least two sets of signals from at least two different axial directions which are in substantial perpendicular relation (e.g., approximately 90°), or alternatively, having an angle that allows to calculate their components in two perpendicular directions. For instance, two single-axis accelerometers which may space apart from each other, or alternatively a single bi-axis accelerometer may interchangeably be used to reach the same desired output. The actual choice will depend on many factors including cost, accuracy, ease of data collection and so on. In a further example, three sets of signals can be generated from where the sensors are positioned at an angle of 60°instead of the aforementioned example of 90°.

As the position of the acceleration sensing device 21 according to the present invention is not known once it is installed, hence a tri-axial accelerometer may be preferred as this provides simultaneous measurements in three orthogonal directions (e.g., axis x, y and z), for the analysis of all of the vibrations and/or motions being experienced by a structure element and/or tensioning element. In this connection, each unit incorporates three separate sensing elements that are oriented at right angles with respect to each other in perpendicular relation. In this connection, it is reiterated that the accelerometer as described herein is a sensor.

The acceleration sensing device 21 as shown in the FIG. 2, similar to those exemplified in the FIG. 1, comprises at least a wire 16, wherein the wire 16 is provided to one or both longitudinal ends of the acceleration sensing device 21. For instance, one longitudinal end may be equipped with a data wire 16a whereas another longitudinal end may be provided with a hoisting wire 16b.

The hoisting wire 16b may serve as a hoist to lift or lower the acceleration sensing device 21 within its recipient 520 such as pipe 521 whereas the data wire 16a may be served as a wire for transmitting data. However, the data wire 16a may also serve as a hoisting wire 16b for lifting or lowering the acceleration sensing device 21 and the datalogger device 30 so that it reaches different locations within its recipient. For instance, when the height adjustable (or mounting-free) acceleration sensing device 21 is provided within a stay pipe 521, the wire 16, 16a, 16a can be used to place the sensing device 20 into the pipe 521 or can be used to remove the device 20 out of the pipe 521. Moreover, a wire connector 18 (as seen in the FIG. 2) may be provided to connect between the accelerometer 14 and the data wire 16a.

The accelerometer used in the sensing device 20 of the present invention is capable of measuring movements between 0 Hz and 100 Hz, preferably between 0 Hz and 50 Hz. However, it does not exclude the possibility that higher frequencies can be measured.

As the acceleration sensing device 21 or at least part of the acceleration sensing system 101 of the present invention is not attached in a fixed manner on a surface of the pipe 521 i.e., without control of the orientation through mounting, for the aforementioned reasons, the system 101 may thus be required to be self-corrected (i.e., pre-treatment of the signals in relation to reference signals) so that the actual orientation of the acceleration sensing device 20 can be corrected and determined.

The reference signal is generated upon sensor calibration according to sensor datasheet parameters followed by sensor orientation correction, wherein the sensor orientation correction calculated from a projection of the averaged acceleration on the vertical axis, wherein the values are obtained from accelerometers installed on two different radial directions.

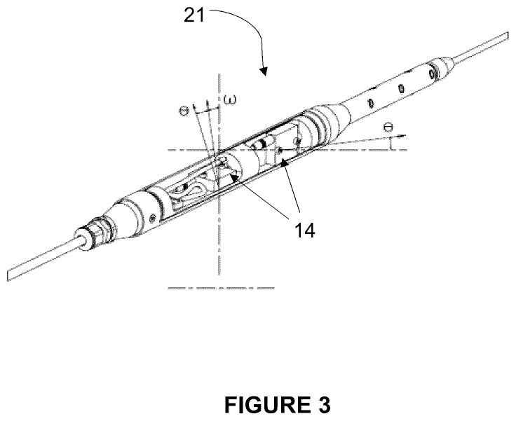

For example, in order to generate the reference signal from the raw signal (out of the accelerometer and digitalized), a minimum of two single-axis accelerometers or an accelerometer in two different axial directions is required. The minimum two accelerometers can be installed at a known angle, substantially perpendicular (for instance as shown in the FIG. 3) or in any two different directions that allow to calculate their projection on two perpendicular axis. Then, sensor calibration is performed according to the parameters of the sensor supplier, and data obtention is performed. An accelerometer capable of measuring gravity acceleration, i.e., DC-response accelerometer is a suitable accelerometer. Next, actual orientation of the acceleration sensing device 21 (which is often the same as the position of the sensor box and the sets of accelerometers when they are in a rigid body) is computed and finally projection of signal according to computed orientation is performed so as to obtain the reference signal.

The microprocessor and the memory may be provided to a processing unit e.g., a datalogger device 30 so as to form a component of the acceleration sensing system 101 for processing and storing of the information such that signals pre-treatment can be performed on the spot and that an output signal can be generated and transmitted to one or more receivers. Alternatively, the signal can be treated remotely.

According to the present invention, it relates also to an installation method of the sensing system 100 to a load-bearing element 500 for measuring physical parameters, such as acceleration, vibrations, temperature, humidity, motion, etc.

For example, one longitudinal end of the acceleration sensing device 21 can be connected to a wire 16 e.g., hoisting wire 16b which in turn is attached to an anchoring area, through for instance wedge anchor having single hole or multi-hole, or at the bearing plate. It is reiterated that the present invention also relates to a monitoring system and method of measuring vibrations and/or motions of a cable.

To this end, it is noted that sufficient wire length may be left available such as at the top side of the accessible area to permit lifting up or lowering down of the sensing device 20 or the sensing system 100. Hence, when maintenance work is carried out, the device 20 or the system 100 can be lifted out from the recipient 520 i.e., stay pipe 521. In this connection, the datalogger device 30 may either be located at the bottom or top end of the recipient 520. In case the datalogger device 30 is located at the top end of the recipient 520, the data wire 16a can be functioned as a hoisting wire 16b to lift the device 20 out of the recipient 520. In other words, the final position of the sensing device 20 and/or the sensing system 100 can be controlled through the length of the wire 16.

According to preferred embodiments of the present invention, the acceleration sensing device 21 according to the present invention is connected to a datalogger device 30 to pre-treat signal in order to correct the accelerometer's random axial orientation. A memory and a microprocessor can thus be provided to the datalogger device 30. As explained, the signals from the accelerometers will be pre-treated in order to correct random axial orientation, thus serving as reference signals, before generating the output signals based on the reference signals.

FIG. 3 shows that two single-axis accelerometer sensors are provided within the acceleration sensing device 21. As the acceleration sensing device 21 is not mounted at a fixed position of its recipient 520, axial orientation of the accelerometers may require to be assessed and corrected before a meaningful signal output can be generated. Each of the accelerometers 14 of the acceleration sensing device 21 as shown in the FIG. 3 is operable to provide for instance an angular position Θ of a static body having moved from a first angular position to a second angular position. According to a further embodiment of the invention, the accelerometer sensor is operable to nullify angular acceleration error contributions associated with measuring the angular position of a body. Θ represents cable inclination; ω represents random axial orientation of sensor.

The present invention overcomes the difficulties and disadvantages of the prior art by providing a sensing device 20 or a sensing system 100 that is not required to be fixed on a surface of its recipient 520 in order to determine physical properties such as vibrations and/or motions through one or more sensors.

The sensing system 100 or the sensing device 20 utilises for instance a first sensor e.g., accelerometer such as single-axis accelerometer, having a first sensing axis for sensing a first acceleration component, and a second sensor (e.g., single-axis accelerometer) for sensing a second acceleration component. The first and the second sensing axes are in substantially perpendicular relation, the first single-axis accelerometer operable to output a first signal proportional to the sensed first acceleration component, and the second sensor (single-axis accelerometer) operable to output a second signal proportional to the sensed second acceleration component, wherein their outputs are being treated to correct the random axial orientation and obtain the reference signals. It is preferred that the first and the second accelerometers are mounted in spaced apart relation on a printed circuit board defining a plane of reference. For instance, the first sensing axis is configured to determine a vertical position while the second sensing axis is configured to determine a horizontal position. To this end, it is pointed out that instead of two single-axis accelerometers, a dual-axis accelerometer sensor can be used. The system 100 also utilizes a microprocessor operable to determine the final output for vibrations and/or motions.

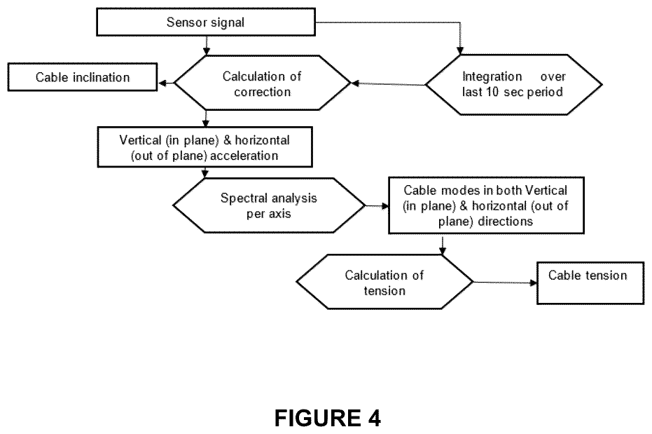

Referring now to the FIG. 4, it illustrates a flow chart of the signal treatment according to an example of the present invention. The raw signals provided by the sensors are processed with the calibration parameters of the datasheet to obtain the accelerations in the direction of the accelerometer. The values of the measured static acceleration are calculated over the last period (preferably between 1 and 50 sec). The actual orientation of the acceleration sensing system is calculated with the measured values in order to obtain the reference signal and the vertical and horizontal acceleration of the tensile element.

The system permits to perform a spectral analysis to determine the cable vibration modes in both the transverse and vertical (in-plan) directions and possibly calculate as the cable tension. For instance, the system described herein is mainly used to assess the force on each tensile element. The vibrations are measured, allowing for an estimation of the cable tension (that is the force in the tensile element).

### REFERENCE LIST

12 casing
14 accelerometer
16 wire
16a data wire
16b hoisting wire
18 wiring connector
20 sensing device
21 acceleration sensing device
30 datalogger device
100 sensing system
101 acceleration sensing system
500 load-bearing element
520 recipient
521 pipe
540 tensile element

1. A sensing system for measuring physical parameters of a structural or tensioning element such as a stay cable or tendon, wherein the structural or tensioning element comprises a recipient as a housing, wherein the sensing system is at least partially provided within the recipient, the sensing system comprising:
A height adjustable sensing device comprising a substantially tubular casing provided within the recipient, wherein at least one sensor is provided within the tubular casing;
A wire for transmitting data and/or for hoisting or lowering the height adjustable sensing device, wherein one end of the height adjustable sensing device is connected to the wire to allow the sensing device to reach any length of the structural or tensioning element.

2. The sensing system according to claim 1, comprising at least one of: an acceleration sensing device, a temperature sensing device, a humidity sensing device, a gas signature sensing device and/or a proximity sensing device.

3. The sensing system according to claim 1, further comprising an acceleration sensing device that comprises at least two single-axis accelerometers, or at least one biaxial accelerometer, or at least one triaxial accelerometer, or a combination thereof.

4. The sensing system according to claim 1, further comprising an accelerometer adapted to measure low frequency of between 0 Hz and 100 Hz.

5. The sensing system according to claim 1, further comprising an accelerometer is adapted to measure 0 Hz acceleration and low frequency motion and/or constant acceleration.

6. The sensing system according to claim 1, further comprising an acceleration sensing device, and a datalogger device to connect with the height adjustable acceleration sensing device for storing and processing of signals.

7. The sensing system according to claim 1, further comprising a transmitting device for broadcasting data to one or more relevant receivers.

8. The sensing system according to claim 1, further comprising a memory for storing information.

9. The sensing system according to claim 1, further comprising an acceleration sensing device, and a microprocessor for processing signals generated by the height adjustable acceleration sensing device in relation to a reference signal to provide an output, wherein the reference signal is obtained upon sensor calibration according to sensor datasheet parameters followed by sensor orientation correction to allow correction of signals without control of position orientation of the height adjustable acceleration sensing device.

10. A load-bearing element for constructions, comprising:
A plurality of tensile elements;
A recipient having an internal cavity such as a pipe for encasing the tensile elements; and
A the sensing system according to claim 1, wherein at least part of the sensing system or the height adjustable sensing device is placed within the recipient without being mounted on a surface of the recipient, allowing the sensing device to reach any length of the recipient.

11. The load-bearing element according to claim 10, wherein a datalogger device is provided to an upstream or a downstream of the load-bearing element.

12. The load-bearing element according to claim 11, wherein the datalogger device is provided to be-located within or outside of the recipient, the datalogger device comprising a memory for storing data, and a microprocessor for processing signals generated by the height adjustable sensing device.

13. A method of installing a sensing system to a load-bearing element for measuring physical parameters of the load-bearing element such as vibrations and/or motion, the method comprising:
Providing tensile elements to a recipient having internal cavity;
Providing a sensing system to the load-bearing element, said sensing system comprising at least one height adjustable sensing device having a substantially tubular casing, wherein the height adjustable sensing device is located within the recipient without being mounted, wherein at least one end of the height adjustable sensing device is connected to a wire which in turn is anchored to an anchoring area, allowing the sensing device to reach any length of the recipient.

14. The method according to claim 13, the at least one height adjustable sensing device comprising an accelerometer, the method further comprising:
connecting the accelerometer with a datalogger device; and
Generating output signals.

15. The method according to claim 13, further comprising hoisting or lowering the wire for adjusting the position of the height adjustable sensing device to reach any length of the recipient.

16. The method according to claim 14, further comprising hoisting or lowering the wire for adjusting the position of the height adjustable sensing device to reach any length of the recipient.

17. The sensing system according to claim 1, further comprising an accelerometer adapted to measure low frequency of between 0 Hz and 50 Hz.

18. The sensing system according to claim 3, further comprising a datalogger device to connect with the height adjustable acceleration sensing device for storing and processing of signals.

19. The sensing system according to claim 4, further comprising a datalogger device to connect with the height adjustable acceleration sensing device for storing and processing of signals.

20. The sensing system according to claim 2, further comprising an acceleration sensing device, and a microprocessor for processing signals generated by the height adjustable acceleration sensing device in relation to a reference signal to provide an output, wherein the reference signal is obtained upon sensor calibration according to sensor datasheet parameters followed by sensor orientation correction to allow correction of signals without control of position orientation of the height adjustable acceleration sensing device.
